(19) United States
(12) Patent Application Publication
(10) Pub. No.: US 2018/0153774 A1
(43) Pub. Date: Jun. 7, 2018

(54) SAFE TABLET CUTTING DEVICE

(71) Applicant: E-LINK PLASTIC & METAL INDUSTRIAL CO., LTD., NEW TAIPEI CITY (TW)

(72) Inventor: CHIH-CHUN LEE, NEW TAIPEI CITY (TW)

(21) Appl. No.: 15/372,339

(22) Filed: Dec. 7, 2016

(51) Int. Cl. A61J 7/00; B26D 3/30

(52) U.S. Cl. CPC A61J 7/0007; B26D 3/30

(57) ABSTRACT

A safe tablet cutting device includes a container having one side open and the other side closed to form an accommodation space in which a positioning portion is formed to fix a tablet. A cover is pivoted to the container to selectively open or close the accommodation space of the container. A cutter is provided inside the cover. A suspension body is pivoted inside the cover and is rotatable between a first position where the cutter is located in a mouth formed in the suspension body and a second position where the cutter protrudes out of the mouth of the suspension body.

### (a) TECHNICAL FIELD OF THE INVENTION

The present invention is related to a safe tablet cutting device and particularly to a safe tablet box provided with a suspension body formed with a mouth through which a cutter is allowed to pass to a side of a positioning portion therein, thereby preventing a user from being cut for achievement of the safe use.

### (b) DESCRIPTION OF THE PRIOR ART

Generally, to effectively carry tablets for easy taking, tablets are placed in a tablet box.

However, a conventional tablet box is merely a box. An accommodation space is formed inside the box, where the tablets are placed. However, the tablets are nowadays limited on the dose of usage, and because each of some kinds of tablets cannot be entirely swallowed, it must be divided into half-and-half parts or four equal parts by means of cutting or stripping for the dose required per meal or day. Thus, when the user needs to divide the tablet, the tablet will be likely to be contaminated by his or her unclean hands if the user simply performs the stripping operation with both hands, thereby making the user not feel good or making the effect of tablet quality decrease. Further, if the user cut the tablet by using an external cutter and the cutter is improperly forced, the tablet easily falls to the ground, or the user might cut his or her finger or fingers if the user is careless or neglectful.

In this way, in order to avoid the above shortcomings, there has been a tablet box introduced in the market to help the user cut the tablet. However, the conventional tablet box functioning to cut tablets is provided with an exposed cutter and the majority of the users using the design is the elderly; thus, they are often cut their finger(s) due to a poor sight problem or the obtuse action of the elderly.

Thus, to solve the drawbacks mentioned above, U.S. Pat. No. 8,474,674 B2, titled Tablet cutter, and US patent No. US20070228053 A1, titled Pill box and splitter with blade guard, are disclosed. However, the plate cutter makes a plate glide up and down in the principle of glide rail operation to further hide the cutter body in the tablet box (when the tablet box is open) by using the plate. However, both sides of the plate are flat, so it is apparent from the physical motion characteristic that the flat surfaces of the two sides of the plate and the flat surfaces of the inner sides of the glide rail that rub against each other are easily damaged and is subject to higher resistance of gliding, and it is thereby inconvenient to use. In addition, the tablet box and the split blade guard separates the cutter body provided in the tablet box cover by using a flexible plate; however, the flexible plate is liable to be elastically fatigued due to long-term overuse and thus the plate cannot effectively isolate the cutter body, which is thereby not a perfect design.

Therefore, in order to avoid the user from being cut, the present invention provides a safe tablet cutting device, improving the safety of use and eliminating the drawbacks of the prior art for increasing the effect.

### SUMMARY OF THE INVENTION

In order to achieve the aforementioned purpose, the present invention provides a safe tablet cutting device, mainly comprises a container and a cover. A side of the container is opened and the other side of the container is closed, thereby an accommodation space being formed. A positioning porion is formed in the container to fix a tablet. A leaning portion is formed at a side of the inner side of the container.

A side of the cover is pivoted to a side of the container to open or close the accommodation space of the inside of the container through the cover. A cutter is provided inside the cover. The other side of the inner side of the cover is pivoted to a suspension body. A side of the suspension body abuts to a side of the leaning portion, while the other side of the suspension body is pivoted to an inner portion of the cover. Further, a mouth is formed at a predetermined portion of the suspension body. The mouth is opposite to the cutter that is allowed to pass through the mouth to a side of the positioning portion.

A buckle part is formed at the other side of the cover to buckle to the other side of the container.

The positioning portion includes a platform and a stopper.

The stopper is an eight-shaped stopper.

The mouth is formed on a random portion at a nearby lower section or middle section of the suspension body.

At least one reinforced portion is formed on a side of the suspension body to enhance the suspension body, thereby preventing a user from being cut by the cutter that is exposed out of the suspension body that is opened or pressed inwards by the user.

An accommodation portion is formed at a bottom side of the platform. The accommodation portion connects to the bottom of the platform for accommodating tablet bits from the tablet being cut.

The foregoing objectives and summary provide only a brief introduction to the present invention. Other objects, features, and advantages of the present invention will become conspicuous to those skilled in the art upon reading the following detailed descriptions accompanying by the illustrations.

### BRIEF DESCRIPTION OF THE DRAWINGS

FIG. 1 is a 3D view of the appearance of a safe tablet cutting device according to this invention.

FIG. 2 is a state view of the opened safe tablet cutting device according to this invention.

FIG. 3 is a service state view of the half opened safe tablet cutting device according to this invention.

FIG. 4 is a schematic view illustrating a cutting state of the safe tablet cutting device according to this invention.

FIG. 5 is a sectional view of a service state of the safe tablet cutting device according to this invention.

FIG. 6 is a service state view of an accommodation portion of the safe tablet cutting device according to this invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

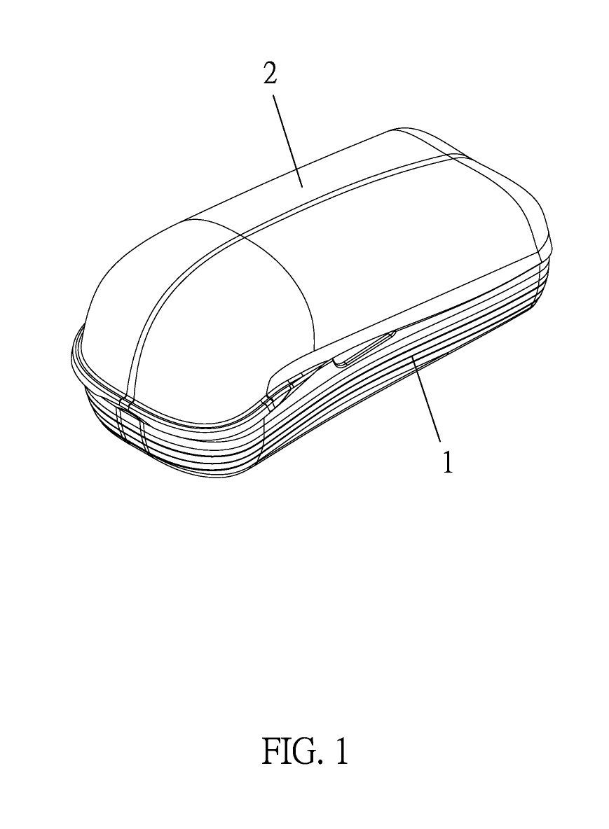

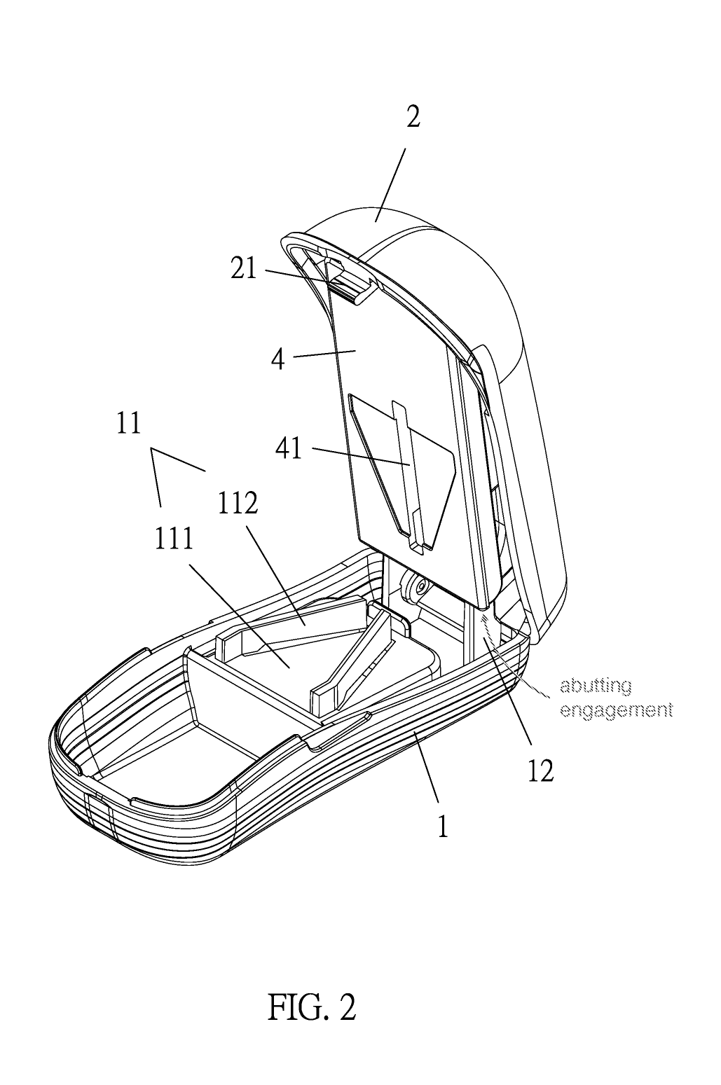

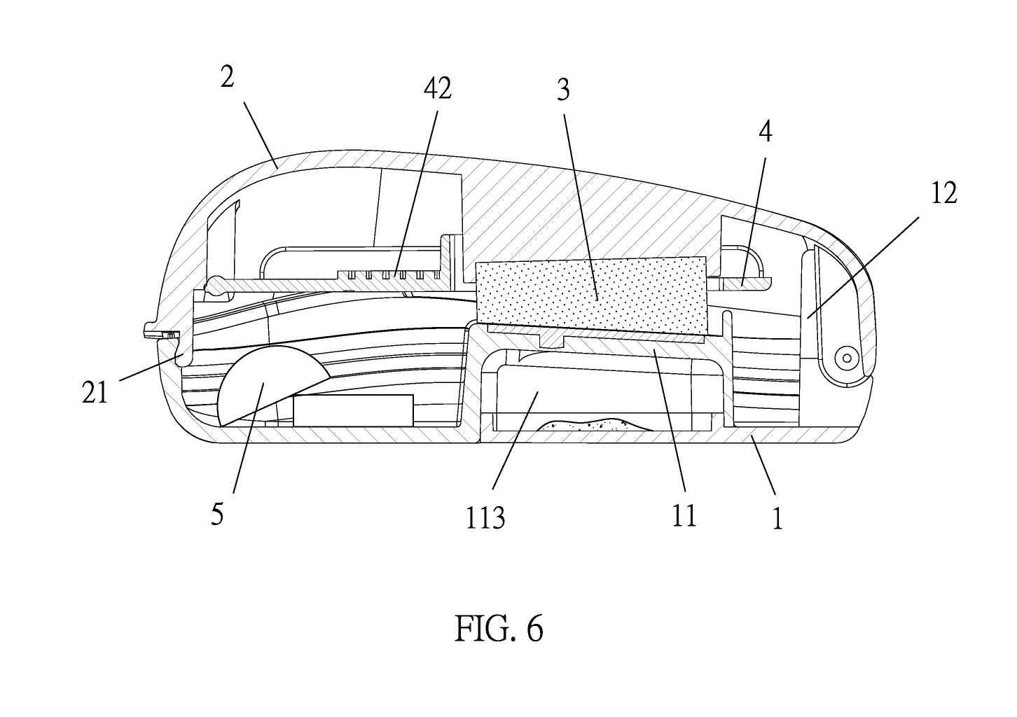

Refer to FIG. 1 through FIG. 3 and FIG. 6 that are respectively a 3D view of the appearance of a safe tablet cutting device, a state view of the opened safe tablet cutting device, a service state view of the half opened safe tablet cutting device, and a service state view of an accommodation portion of the safe tablet cutting device according to this invention. As shown in the figures, a safe tablet cutting device according to this invention comprises a container 1 and a cover 2. A side of the container 1 is opened and the other side of the container 1 is closed, thereby an accommodation space being formed. A positioning portion 11 is formed in the container 1 to fix a tablet. The positioning portion 11 includes a platform 111 and a stopper 112. An accommodation portion 113 is formed at a bottom side of the platform 111. The accommodation portion 113 connects to the bottom of the platform 111 for accommodating tablet bits from the tablet being cut. The stopper 112 is an eight-shaped stopper. A leaning portion 12 is formed at a side of the inner side of the container 1.

A side of the cover 2 is pivoted to a side of the container 1 to open or close the accommodation space of the inside of the container 1 through the cover 2. A cutter 3 is provided inside the cover 2. The other side of the inner side of the cover 2 is pivoted to a suspension body 4. A side of the suspension body 4 abuts to a side of the leaning portion 12, while the other side of the suspension body 4 is pivoted to an inner portion of the cover 2. The mouth 41 is formed on a random portion at a nearby lower section or middle section of the suspension body 4. The mouth 41 is opposite to the cutter 3 that is allowed to pass through the mouth 41 to a side of the positioning portion 11. At least one reinforced portion 42 is formed on a side of the suspension body 4 to enhance the suspension body 4, thereby preventing a user from being cut by the cutter 3 that is exposed out of the suspension body 4 that is opened or pressed inwards by the user. A buckle part 21 is formed at the other side of the cover 2 to buckle to the other side of the container 1.

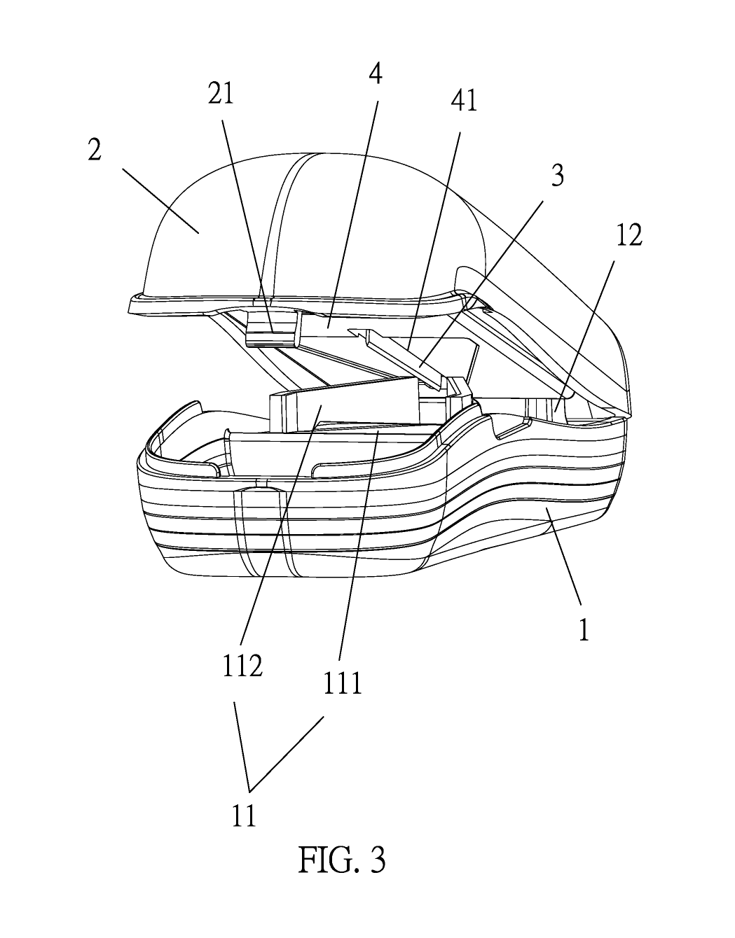

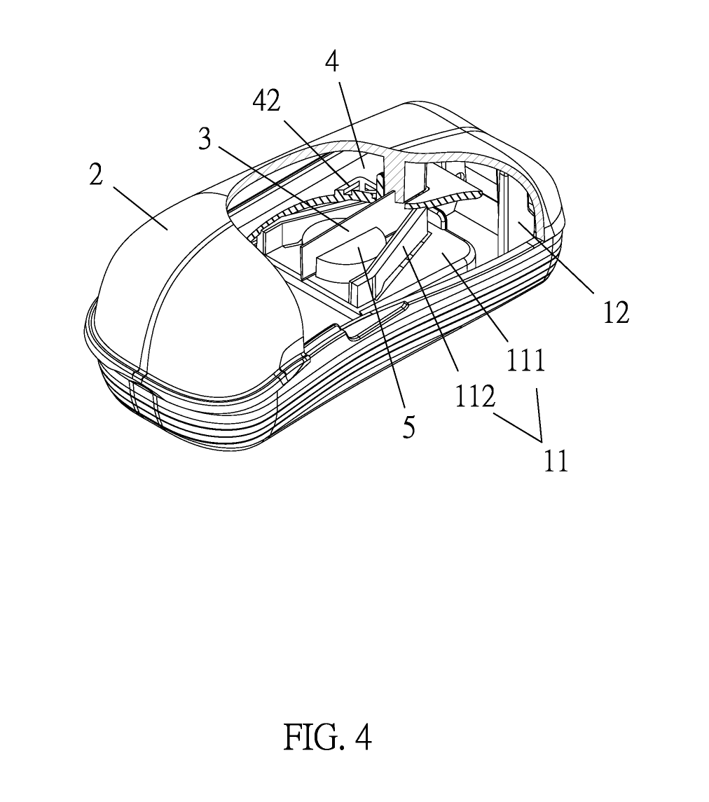

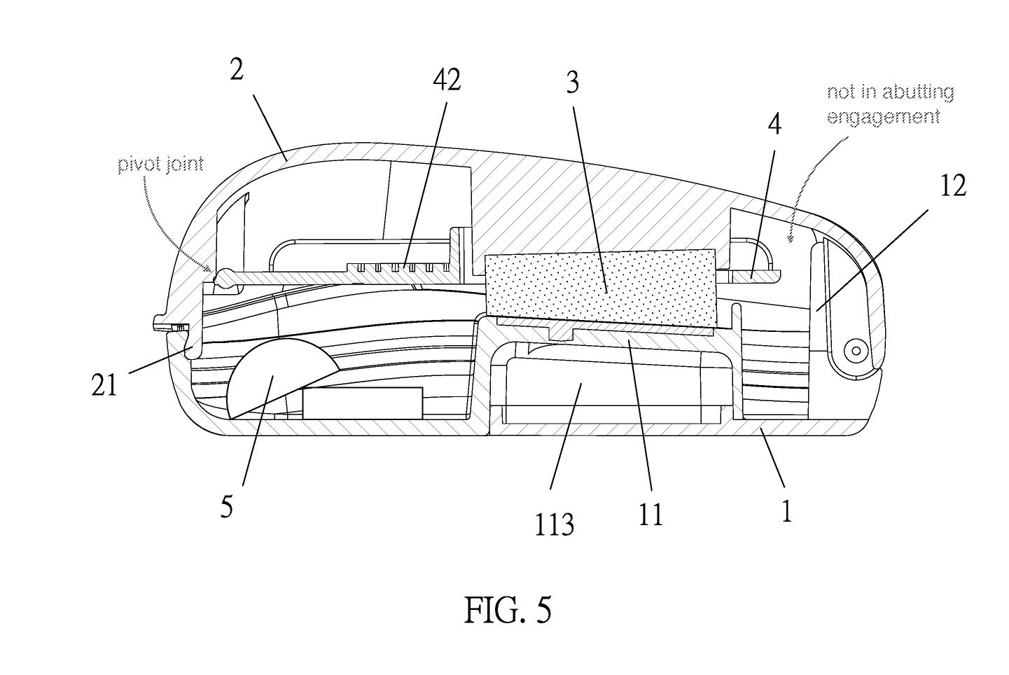

Refer to FIG. 3 through FIG. 6 that are respectively a service state view of the half opened safe tablet cutting device, a schematic view illustrating a cutting state of the safe tablet cutting device, a sectional view of a service state of the safe tablet cutting device, and a service state view of an accommodation portion of the safe tablet cutting device according to this invention. As shown in the figures, a tablet 5 is placed on the positioning portion 11 formed inside the container 1. The tablet 5 is located on a side of the platform 111 and is effectively fixed by the stopper 112. Therefore, when the cover 2 covers the opened side of the container 1, the suspension body 4 is pushed with a force by its one side abutting the stopper 112. Then, an end of the suspension body 4 moves up along the leaning portion 12. In this moment, the mouth 41 is opposite to the cutter 3, thereby the cutter 3 being made to pass through the mouth 41 to a side of the platform when the suspension body 4 moves upwards. When the cover 2 fits completely to the container 1, the cover 2 may buckle with the container 1 through the buckle part 21. The cutter 3 can thereby effectively cut the tablet 5. After being cut, the tablet 5 can be placed in the accommodation space inside the container 1, thereby the tablet 5 being stored effectively. Oppositely, when the cover 2 is being opened, a side of the suspension body 4 makes a side of the suspension body 4 move forward because the leaning portion 12 is buckled with a side of the suspension body 4, and further hides the cutter 3 behind the suspension body 4. Therefore, the user would not be cut by the cutter 3 exposed outside.

In summary, the present invention provides a safe tablet cutting device, effectively improving the shortcomings of conventional products. To sum up, this invention is an available, novel, and progressive in the industry, completely meets the requirements of application for the patent, and hence we apply following the patent law; we earnestly request you to examine it for details and to approve the patent as soon as possible for protection of the inventor s rights and interests.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A safe tablet cutting device, comprising:
a container, a side of the container being opened and the other side of the container being closed, thereby an accommodation space being formed, a positioning portion being formed in the container to fix a tablet, and a leaning portion being formed at a side of the inner side of the container; and
a cover, a side of the cover being pivoted to a side of the container to open or close the accommodation space of the inside of the container through the cover, a cutter being provided and mounted inside the cover, the other side of the inner side of the cover being pivoted to a suspension body, a side of the suspension body selectively abutting a side of the leaning portion and the other side of the suspension body being pivoted to an inner portion of the cover, a mouth being formed at a predetermined portion of the suspension body, and the mouth being opposite to the cutter that is allowed to pass through the mouth to a side of the positioning portion;
wherein the suspension body that is pivoted to the cover is rotatable between a first position where the cutter is located inside the mouth and a second position where the cutter passes through the mouth to protrude out of the mouth.

2. The safe tablet cutting device according to claim 1, wherein a buckle part is formed at the other side of the cover to buckle to the other side of the container.

3. The safe tablet cutting device according to claim 1, wherein the positioning portion includes a platform and a stopper.

4. The safe tablet cutting device according to claim 3, wherein an accommodation portion is formed at a bottom side of the platform and the accommodation portion connects to the bottom of the platform for accommodating tablet bits from the tablet being cut.

5. The safe tablet cutting device according to claim 3, wherein the stopper is an eight-shaped stopper.

6. The safe tablet cutting device according to claim 1, wherein the mouth is formed on a random portion at a nearby lower section or middle section of the suspension body.

7. The safe tablet cutting device according to claim 1, wherein at least one reinforced portion is formed on a side of the suspension body to enhance the suspension body, thereby preventing a user from being cut by the cutter that is exposed out of the suspension body that is opened or pressed inwards by the user.
